(19) United States
(12) Patent Application Publication
(10) Pub. No.: US 2010/0128797 A1
(43) Pub. Date: May 27, 2010

(54) Encoding Of An Image Frame As Independent Regions

(75) Inventor: Soumen Kumar Dey, Pune (IN)

Correspondence Address: NVIDIA C/O MURABITO, HAO & BARNES LLP, TWO NORTH MARKET STREET, THIRD FLOOR, SAN JOSE, CA, 95113, US

(73) Assignee: NVIDIA Corporation, Santa Clara, CA (US)

(21) Appl. No.: 12/277,277

(22) Filed: Nov. 24, 2008

(51) Int. Cl. H04B 1/66

(52) U.S. Cl. 375/240.24; 375/E07.075

(57) ABSTRACT

An aspect of the present invention dynamically allocates specific blocks of an image frame to each region based on a desired number of regions and a type of regions. According to another aspect of the present invention, the values of parameters used for encoding individual regions are also dynamically computed. Due to such dynamic allocation and computations, the encoding approach may scale easily to address a large variety of image frames.

### COPYRIGHT NOTICE

A portion of the disclosure of this patent document contains material which is subject to copyright protection. The copyright owner, Nvidia Corporation, has no objection to the facsimile reproduction by anyone of the patent document or the patent disclosure, as it appears in the US Patent and Trademark Office patent file or records, but otherwise reserves all copyright rights whatsoever.

### BACKGROUND

1. Field of Disclosure

The present disclosure relates generally to data encoding, and more specifically to encoding of an image frame as independent regions.

2. Related Art

An image frame is data representing a source image. An image frame generally contains digital values (“pixels”) each representing a corresponding point (small region) of the image. The points (of the source image) and the corresponding pixels (data) are used interchangeably unless the specific context requires differentiation between the two.

Image frames are often required to be encoded (converted to another data format), typically for compression and/or enhanced security. The encoded image frame may be later decoded to generate a reconstructed image frame, which represents the image as close as possible.

H.264/AVC (hereafter “H.264”) is an example standard using which image frames is represented in an encoded/compressed form. H.264 is described in further detail in “Information technology—Coding of audio-visual objects—Part 10: Advanced Video Coding”, available from ISO/IEC (International Standards Organization/International Electrotechnical Commission).

Typical encoding entails dividing a source image into multiple regions. For example, in case of H.264 standard, the regions are termed as slice groups. Each region is encoded independently, implying that the encoding of pixels in one region is performed without using the pixels in other regions.

Independent encoding enables each region to be decoded from its corresponding encoded data alone (i.e., without needing the encoded data of the other regions). Such a feature may be desirable when a sequence of images constituting a video signal is transmitted over a communication path since received data corresponding to one region can be processed without waiting for data of other regions. In addition, different regions can be encoded with corresponding desired compression levels, etc., as is well known in the relevant arts.

Several aspects of the present invention provide for flexible encoding of an image frame as independent regions.

### BRIEF DESCRIPTION OF THE DRAWINGS

Example embodiments will be described with reference to the following accompanying drawings, which are described briefly below.

FIG. 1 is a block diagram of an example environment in which several aspects of the present invention can be implemented.

FIG. 2A is a block diagram illustrating encoding of image frames in an embodiment.

FIG. 2B is a block diagram illustrating decoding of image frames in an embodiment.

FIG. 2C is a diagram illustrating the manner in which an image frame is divided into blocks in an embodiment.

FIG. 3 is a flow chart illustrating the manner in which image frames are encoded according to an aspect of the present invention.

FIG. 4A is a diagram used to illustrate the manner in which an image frame of raster scan type is encoded in an embodiment of the present invention.

FIG. 4B is a diagram used to illustrate the manner in which an image frame of WIPE type is encoded in an embodiment of the present invention.

FIG. 4C is a diagram used to illustrate the manner in which an image frame of Box out type is encoded in an embodiment of the present invention.

FIG. 4D is a diagram used to illustrate the manner in which an image frame of interleaved type is encoded in an embodiment of the present invention.

FIG. 4E is a diagram used to illustrate the manner in which an image frame of foreground/background type is encoded in an embodiment of the present invention.

FIG. 5 is a block diagram illustrating the details of a digital processing system in which various features of the present invention are operative upon execution of software instructions.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

1. Overview

An aspect of the present invention dynamically allocates specific blocks of an image frame to each region based on a desired number of regions and a type of regions. In an embodiment, the desired number of regions and a desired type for the regions may be received, and the number of blocks in an image frame is computed first based on the number of pixels in each dimension of the image frame. The number of blocks in each region is then determined based on the desired number of regions. Each block is then assigned to one of the regions based on the type of regions.

According to another aspect of the present invention, the values of parameters used for encoding individual regions are also dynamically computed. In an embodiment, the parameters determine the start (or first) block in each region and the sequence in which the rest of the allocated blocks of the region are encoded. An encoder may accordingly independently encode such sequence of blocks of each region.

Due to such dynamic allocation and computations, the encoding approach may scale easily to address a large variety of image frames. The features are illustrated with respect to H.264 standard.

Several aspects of the invention are described below with reference to examples for illustration. However one skilled in the relevant art will recognize that the invention can be practiced without one or more of the specific details or with other methods, components, materials and so forth. In other instances, well-known structures, materials, or operations are not shown in detail to avoid obscuring the features of the invention. Furthermore the features/aspects described can be practiced in various combinations, though only some of the combinations are described herein for conciseness.

2. Example Environment

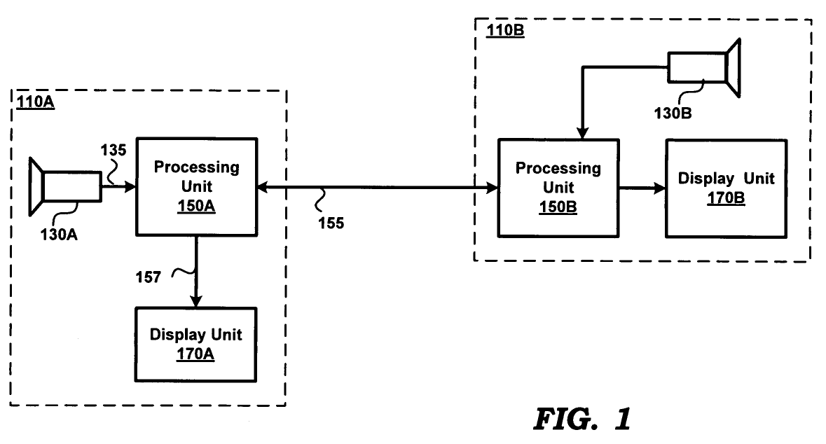

FIG. 1 is a block diagram illustrating an example environment in which several features of the present invention may be implemented. The example environment is shown containing only representative systems for illustration. However, real-world environments may contain many more systems/components as will be apparent to one skilled in the relevant arts by reading the disclosure provided herein. Implementations in such environments are also contemplated to be within the scope and spirit of various aspects of the present invention.

The diagram is shown containing end systems 110A and 110B designed/configured to communicate with each other in a video conferencing application. End system 110A is shown containing processing unit 150A, video camera 130A, and display unit 170A, while end system 110B is shown containing processing unit 150B, video camera 130B, and display unit 170B. Each component is described in detail below.

Video camera 130A captures images of a scene (a general area sought to be captured), and forwards the captured image to processing unit 150A via path 135. The captured image is forwarded in the form of corresponding image frames, with each image frame containing a set of pixel values representing the captured image when viewed as a two-dimensional area. The image frames (generally in an uncompressed format) may be forwarded from video camera 130A in any of formats such as RGB, YUV, etc.

Processing unit 150A may compress/encode each image frame received from video camera 130A, and forward the compressed/encoded image frames via path 155 to end system 110B. Path 155 may contain various transmission paths (including networks, point-to-point lines, etc.) providing a bandwidth for transmission of the image/video data.

Alternatively, processing unit 150A may store the compressed/encoded image frames in a memory (not shown). Processing unit 150A may also receive compressed/encoded image data from end system 110B, and forward the uncompressed/decoded image data (representing the reconstructed scene) to display unit 170A via path 157 for display.

Processing unit 150B, video camera 130B and display unit 170B respectively operate similar to the corresponding components of end system 110A (and vice versa), and the description is not repeated for conciseness. With respect to processing of compressed image frames, end system 110B may reconstruct the scene by decompressing/decoding the image frames received from end system 110A and then may display the reconstructed scene on display unit 170B. Such reconstruction may be performed in both processing unit 150A and 150B.

Processing unit 150A may divide the image frame (received from video camera 130A) into regions for processing particularly for encoding, transmission and storage. Each region may then be encoded and transmitted individually (independent of each other) to processing unit 150B in end system 110B for decoding and display in display unit 170B. It may be noted that processing unit 150B may also operate similar to that of 150A on the image frames received from video camera 130B by dividing them into regions.

Several features of the present invention of determining the regions to be used for encoding an image frame is described below in a specific context of H.264 standard. However, it should be appreciated that the features can be implemented with respect to other encoding/decoding of image frames in other contexts and/or other standards as well where the image frame data can be represented as regions, as will be apparent to one skilled in the relevant arts by reading the disclosure provided herein.

3. H.264 Standard

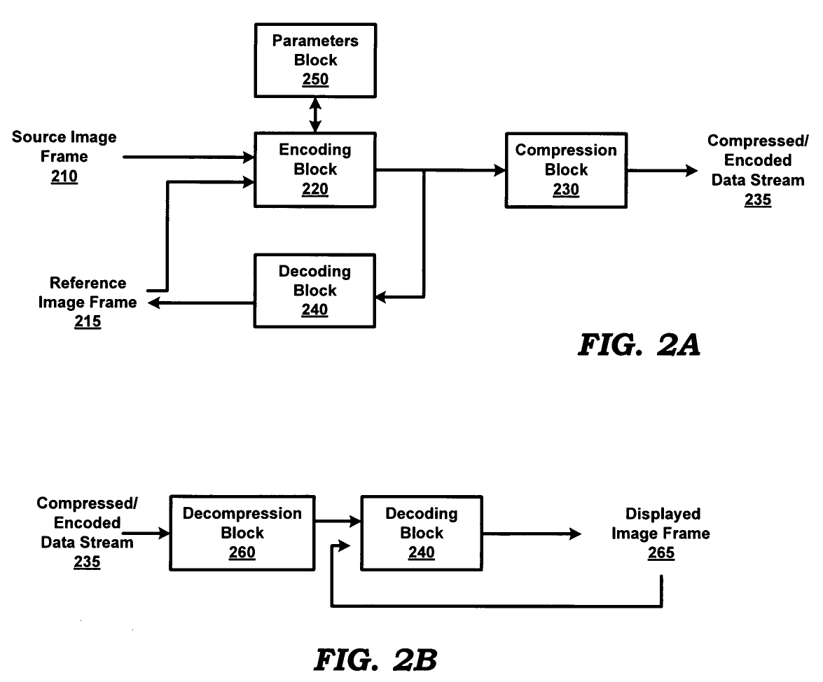

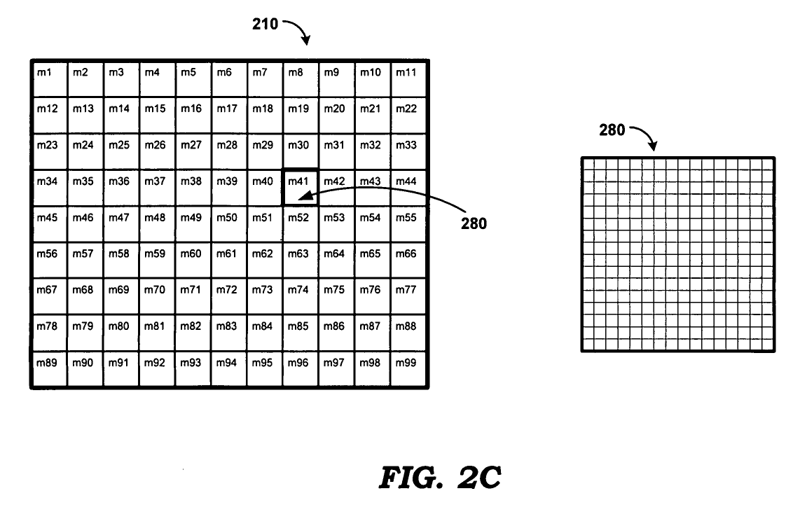

FIG. 2A is block diagram of the internal details of an H.264 encoder illustrating an example embodiment in which several features of the present invention are implemented. The encoder may be implemented within processing unit 150A or externally (e.g., using custom ASICs).

Only some of the details as pertinent to the features described below are shown for conciseness. For further details of the H.264 standard, the reader is referred to the document noted in the Background section. Further, though shown as separate blocks with distinct functionalities merely for illustration, the various blocks of FIGS. 2A and 2B may be implemented as more/fewer blocks, possibly with some of the functionalities merged/split into one/multiple blocks.

The block diagram is shown containing source image frame 210, reference image frame 215, encoding block 220, compression block 230, compressed/encoded bit stream 235, decoding block 240, and parameter block 250. Each block is described in detail below.

Source image frame 210 represents one of the image frames received from video camera 130A desired to be compressed/encoded according to the H.264 standard. In one embodiment, each source image frame is encoded using a block-based compression encoding technique as described below.

FIG. 2C depicts the manner in which image frames are compressed/encoded using a block-based compression/encoding technique in one embodiment. In a block-based technique, an image frame is viewed as containing multiple blocks, with each block representing a group of adjacent pixels with a desired dimension and shape. The encoding and decoding of the image frame may then be performed based on the blocks in the image frame.

In H.264 standard, each (macro) block is chosen to be a square block of 16×16 pixels size as shown for block 280. However, an image frame can be divided into square blocks of other sizes, such 4×4 and 8×8 pixels. Further, the blocks can be of other shapes (e.g., rectangle or non-uniform shape) and/or sizes in alternative standards. Each block is hereafter referred to as a macro-block.

Each macro-block represents a group of pixels which are processed together (i.e., cannot be split into different regions) while compressing/encoding source image frame 210. Accordingly, source image frame 210 (assumed to be 176 pixels wide and 144 pixels high) is shown as being divided into 99 macro-blocks (shown numbered sequentially from m1 to m99 for reference). Encoding block 220 encodes the received source image frame 210 using reference image frame 215 according to H.264 standard.

Reference image frame 215 generally represents a reconstructed image frame corresponding to a previous image frame received from video camera 130A prior to (the present) source image frame 210 being compressed. Reference image frame 215 may be generated by decoding block 240 and in general is not similar to the previous image frame due to lossy video compression schemes.

Each macro-block (such as block 280) is encoded by first finding the difference between the values of the (16×16) pixels in the macro-block and the values of the corresponding pixels in a reference macro-block (contained in source image frame 210 or reference image frame 215). Encoding block 220 then encodes the differences to generate a corresponding encoded macro-block data, as is well known in the relevant arts.

Source image frame 210 is often divided into regions/slice groups containing a corresponding set of macro-blocks. Encoding block 220 then encodes macro-blocks in a region using reference macro-blocks selected in the same region, thus ensuring that each region is encoded independent of each other. For example, encoding block 220 may use macro-block information of macro-blocks of the same selected region from the top, left or any other relevant macro-blocks. Within a frame, macro-blocks of one region are independent of other regions, thereby ensuring that frames of other regions may be decoded even if data corresponding to another region is corrupted. It should be noted that each slice group may be further divided into slices, with each slice containing a contiguous sequence of macro-blocks in a specific scan order (left to right and top to bottom).

In one prior embodiment, encoding block 220 identifies the specific/reference macro-blocks in a region/slice group based on the pre-specified values for various parameters used for encoding. The parameters are pre-determined and stored in the form of look up tables, with encoding block 220 designed to look up the values of the pre-defined parameters based on the dimensions of the image frame sought to be encoded, the type/level of encoding desired, etc.

Encoding block 220 then assembles the encoded macro-block data corresponding to the macro-blocks forming source image frame 210 to form the encoded image data and forwards (makes available) the encoded image data to compression block 230.Compression block 230 further compresses encoded image data using entropy-encoding techniques, well known in the relevant arts.

The compressed/encoded image data is then generated in the form of compressed/encoded data stream 235 (containing a set of values in encoded format), which may then either be stored or transmitted to a recipient system such as end system 110B. Compressed/encoded data stream 235 may represent the entire image frame in a compressed/encoded form, and may include information (such as size/dimension/shape of each of the corresponding macro-blocks and slice groups/regions) to enable a device (such as processing unit 150B of FIG. 1) to decompress/decode the image frame/portions of image frame accurately.

Decoding block 240 receives the output of encoding block 220 and decodes the encoded image data. Such decoding may be necessary to generate reference image frame 215 to be used in encoding the next image frame received from video camera 130A.

Decoding block 240 reconstructs the macro-block from the corresponding macro-block data, as well as previously decoded macro-blocks which may be retrieved from a storage unit (not shown). Decoding block 240 then assembles the reconstructed macro-blocks to generate a reconstructed image frame. Decoding block 240 may further apply a deblocking filter (to remove visual defects in the reconstructed image frame) to generate reference image frame 215.

It may be appreciated that a similar approach may be used in decompressing/decoding the compressed/encoded data stream 235 as described in detail below.

FIG. 2B is a block diagram of the internal details of an H.264 decoder illustrating an example embodiment. The decoder may be implemented within processing unit 150B or externally (e.g., using custom ASICs). Only some of the details as pertinent to the features described below are shown for conciseness.

Decompression block 260 receives the compressed/encoded image frame in the form of compressed/encoded data stream 235 and may substantially perform the inverse/reverse of the operations performed by compression block 230 to generate the encoded image data. Decompression block 260 may then forward the encoded image data to decoding block 240.

Decoding block 240 reconstructs the image frame from the encoded image data and then applies a deblocking filter to generate displayed image frame 265. Displayed image frame 265 may be displayed on display unit 170B. It may be appreciated that displayed image frame 265 corresponds (at least substantially) to source image frame 210 after being compressed and decompressed according to H.264 standard.

Thus, a source image frame is encoded and decoded according to the H.264 standard. It may be appreciated that in order for the H.264 encoder to support the encoding of different image frames, it may be necessary that a substantially large lookup table/storage be provided to handle the different combinations of dimensions, levels etc. It may be desirable that the determination of the values of parameters be improved, at least to overcome some of the limitations described above.

One problem with the prior art approach noted above (in which lookup table based approach is used to determine various values) is that the size of the table may become unmanageably large due to the number of possibilities that need to be taken into account in forming the table. For example, the number of possible dimensions of images is increasing and the table size accordingly may become unmanageably large.

Parameters block 250, provided according to various aspects of the present invention, dynamically computes the values of the pre-determined parameters required by encoding block 220 (to overcome at least the above noted problem). Though shown separately, parameters block 250 may be implemented as part of encoding block 220 or external to the H.264 encoder. The manner in which parameters block 250 computes the values of the parameters determining the regions suitable for independent encoding in an image frame is described below with examples.

4. Determining Regions for Independent Encoding in an Image Frame

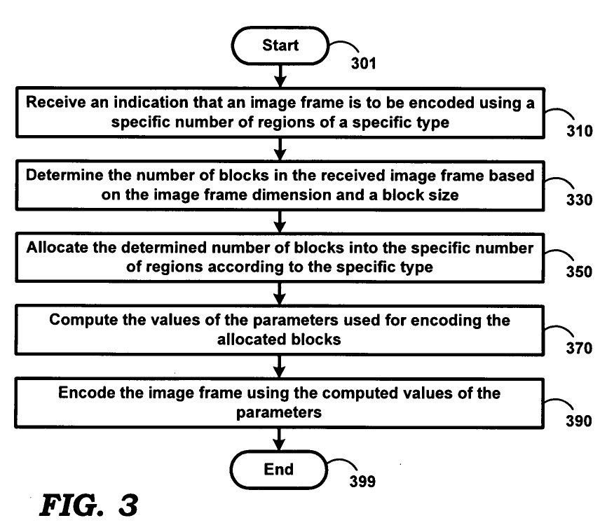

FIG. 3 is a flowchart illustrating the manner in which the regions to be used for independent encoding in an image frame are determined according to an aspect of the present invention. The flowchart is described with respect to FIG. 2A and 2C, merely for illustration. However, various features can be implemented in other environments and other components.

Further, the steps are described in a specific sequence merely for illustration. Alternative embodiments in other environments, using other components and different sequence of steps can also be implemented without departing from the scope and spirit of several aspects of the present invention, as will be apparent to one skilled in the relevant arts by reading the disclosure provided herein. The flowchart starts in step 301, in which control passes immediately to step 310.

In step 310, parameters block 250 receives an indication that an image frame is to be encoded using a specific number of regions of a specific type. The indication along with the specific number of regions and type may be received from the encoding block 220 or may be received along with the source image frame (for example, from video unit 130A).

The specific number of regions indicates the number of slice groups (regions) into which the source image frame is sought to be divided. In H.264 standard, the number of slice groups/regions can have a value between 1 (indicating that the whole image is to be considered as a single slice group) and 8, the maximum number of slice groups allowed for each image frame.

The slice group/region type indicates the manner in which the image frame is divided into the specific number of regions/slice groups. In H.264 standard, the slice group type may be one of interleaved or type 0, dispersed or type 1, foreground/background or type 2, box out or type 3, raster scan or type 4, and WIPE or type 5. Some of the types are described below.

In step 330, parameters block 250 determines the number of blocks in the received image frame based on the image frame dimension (width and height) and a block size. The dimension of the image frame may be received along with the image frame (for example, from video system 130A). Block size may be provided by the encoding block 220 or may be embedded in the software/hardware/firmware of parameters block 250.

To determine the number of blocks in the received image frame, the width and height of the received image frame (in terms of number of pixels) are divided respectively by the width and height of the block (block size) to obtain the number of blocks in the respective dimensions (width and height). The number of blocks in the received image frame is then calculated as the product of the width and height of the image frame in terms of blocks.

In H.264 standard, wherein a macro-block size is 16×16 pixels (as shown for block 280), the width and height of the received image frame are respectively divided by 16 to determine the dimension in terms of macro-blocks. Thus, source image frame 210 in FIG. 2C having a width of 176 pixels and a height of 144 pixels may be viewed as having a width of 11 (176/16) macro-blocks and height of 9 (144/16) macro-blocks. The number of macro-blocks in the received image frame is then determined to be 99 (11×9).

In step 350, parameters block 250 allocates the determined number of blocks into the specific number of regions according to the specific type. The allocation may be performed based on the specific manner in which the received image frame is sought to be divided as indicated by the specific type.

In one embodiment, the total number of blocks in the received image frame is divided approximately equal among the number of regions into which the image frame is sought to be divided. For example, if source image frame 210 is sought to be divided into 3 regions/slice groups, the allocation is performed such that approximately 33 blocks are included in each region/slice group.

Such an allocation of approximately equal number of macro-blocks to the different regions may be desirable at least that the memory required be equal size to store the encoded data of each region. The memory requirement is often dependent on the maximum number of macro-blocks in a slice group, and an approximate equal allocation enables the same memory to be used for processing the different slice groups.

In step 370, parameters block 250 computes/calculates the values of the (pre-determined) parameters used for encoding the allocated blocks (for example, by encoding block 220). Computation implies performance of mathematical operations (instead of the operations associated with retrieval, as described above with respect to prior art) in generating the values. The computed values of the parameters determine the specific set of blocks constituting each region/slice group of the image frame.

For example, interleaved type (type 0) of H2.64 standard requires the values of a parameter called “run length” corresponding to each region/slice group. Run length typically indicates the number of macro-blocks to include sequentially in each region while moving in a scan order left to right before beginning the next region.

Thus, when source image frame 210 is sought to be encoded using 3 slice groups of interleaved type, the run length parameter values are computed to be 33, 33 and 33 indicating that the macro-blocks m1-m33, macro-blocks m34-m66 and m67-m99 form the 3 slice groups.

In step 390, parameters block 250 sends the computed values of the parameters to a H.264 encoder (such as encoding block 220) which then encodes the image frame using the computed values. Thus, in the above example, the computed values 33, 33 and 33 of the run length parameter are sent to the encoder, which then encodes source image frame 210 as three different slice groups (containing macro-blocks m1-m33, m34-m66 and m37-m99) of interleaved type.

The determined slice groups may be encoded individually for convenient storage (not shown) and transmission (forwarding) to decoding block 240 for decoding/reconstructing of the reconstructed image frame 265 to be displayed on 170B. The flow chart ends in step 399.

Thus, the regions suitable for independent encoding in an image frame is determined by parameters block 250 in response to receiving the number/type of regions and the dimensions of the image frame. The manner in which the values for the parameters determining the regions/slice groups are determined in one embodiment is described below with examples.

5. Example Implementation

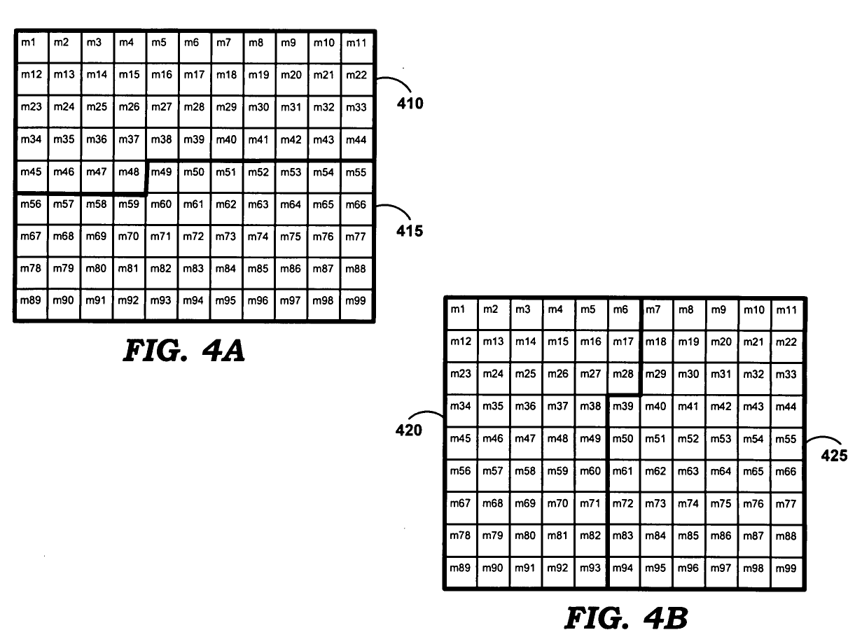

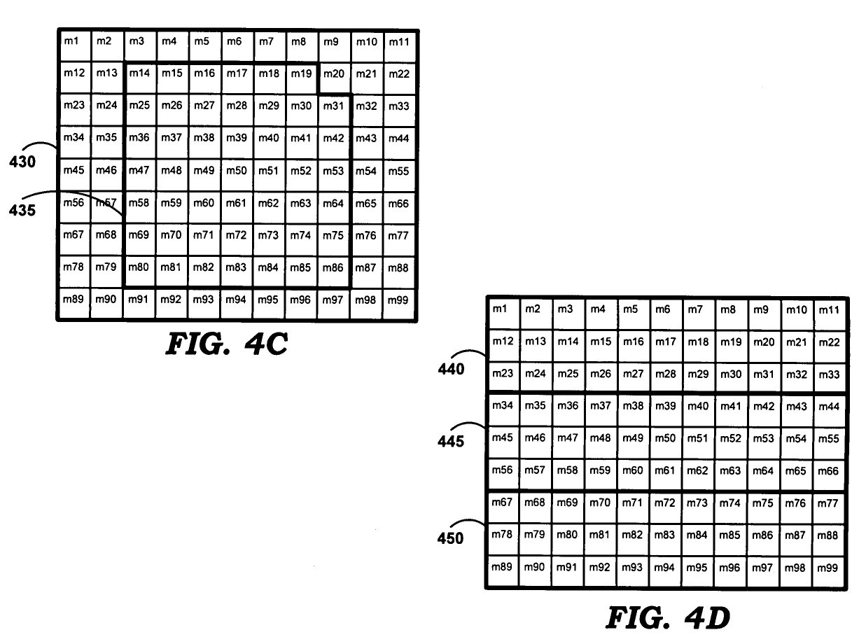

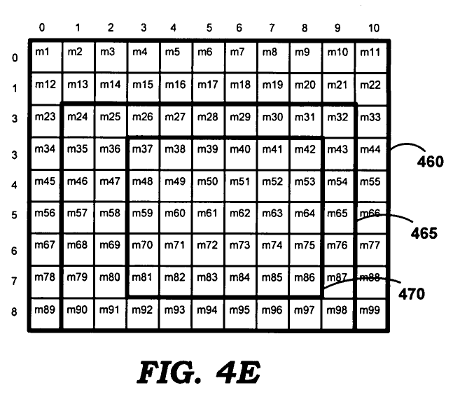

FIGS. 4A-4E together illustrates the manner in which the values for parameters determining the regions suitable for independent implementation in an image frame are computed in one embodiment.

Several aspects of the present invention are shown implemented using software instructions. Further, the software instructions are shown in terms of pseudo-code similar to C programming language, well known in the relevant arts. However, several embodiments of present invention can be implemented using other languages, without departing from the scope and spirit of the present invention.

Further, the names of the variables are chosen to closely describe the function (utility) provided by the corresponding variables. While only a skeleton of the program logic is provided for conciseness, it should be appreciated that the implementation of the entire program logic(s) will be apparent to one skilled in the relevant arts by reading the disclosure provided herein.

For illustration, only the computing of the parameters for raster scan, WIPE, box out, interleaved and foreground/background types for H.264 standard are described below. However, the approaches described below may be modified and/or extended for other similar or different types of regions/slice groups and standards.

6. Determining Regions for Raster Scan, WIPE, Box Out Types

First, the region types are described briefly, as a basis to then describe how the regions are formed according to several aspects of the present invention.

FIG. 4A depicts the manner in which an image frame is divided into slice groups according to raster scan type (or type-4 in H.264 standard) in one embodiment. Raster scan refers to a scan performed when image frame 210 is displayed on a display unit. The scan is typically performed for each row from left to right (m1 to m11) while moving from top to bottom (that is, the first row m1-m11 followed by the second row m12-m22, and so on).

Assuming that the number of slice groups is 2, image frame 210 may be accordingly divided into slice groups/regions 410 (containing macro-blocks m0-m48) and 415 (containing m49-m99)

FIG. 4B depicts the manner in which an image frame is divided into slice groups according to WIPE type (or type-5 in H.264 standard) in one embodiment. The scan is typically performed for each column from top to bottom (m1, m12, m23 . . . m89—first column) while moving from left to right that is, the first column, followed by the second column and so on).

Assuming that the number of slice groups is 2, image frame 210 may be accordingly divided into slice groups/regions 420 (containing macro-blocks in first few columns) and 425 (next few columns).

FIG. 4C depicts the manner in which an image frame is divided into slice groups according to Box Out type (or type-3 in H.264 standard) in one embodiment. The scan is typically performed from the central macro-block (starting at m50) while moving in a clockwise direction moving towards the macro blocks in the edges and ‘growth’ happening in the form of a spiral.

Assuming that the number of slice groups is 2, image frame 210 may be accordingly divided into slice groups/regions 435 (containing macro-blocks shown within the outline) and 430 (containing rest of the macro-blocks not part of 435).

In one embodiment, the H.264 encoder handles the raster scan, WIPE and box out types together since the three types have a fixed number (2) of regions/slice groups. Accordingly, the H.264 encoder requires values corresponding to three parameters when encoding an image frame according to the raster scan (type 4), WIPE (type 5) and Box Out (type 3) types. The three parameters are the direction in which macro-blocks are allocated for raster scan type, for example, left-to-right or right-to-left (represented by the variable “slice_group_change_direction_flag”), the multiple in number of slice group map units by which the size of the slice group can change from one frame/picture to another (represented by the variable “slice_group_change_rate_minus_{—}1”) and to derive the number of slice group map units in the first slice group (also referred as slice group 0 represented by the variable “slice_group_change_cycle”).

The intermediate variables before calculating the parameters are calculated as follows in one embodiment (for a 16×16 macro-block):

PicWidthInMbs=(VideoWidth>>4);

PicHeightInMbs=(VideoHeight>>4);

PicSizeInMapUnits=PicWidthInMbs*PicHeightInMbs;

SliceGroupChangeRate=(PicSizeInMapUnits/NumSliceGroups)

wherein VideoWidth (provided as input) is the width of the image frame in pixels,

VideoHeight (provided as input) is the height of the image frame in pixels and

NumSlicegroups (provided as input) is the number of slice groups (regions) into which the image frame is sought to be divided,

PictureWidthInMbs is a variable storing the value of image frame width in macro-blocks,

PicHeightInMbs is a variable storing the value of image frame height in macro-blocks,

PicSizeInMapUnits is the picture size in macro-block units,

SliceGroupChangeRate stores the allocated number of macro-blocks to each slice group before the calculation of the parameters.

The required parameters are then calculated as follows using the intermediate variables:

slice_group_change_direction_flag=0;

slice_group_change_rate_minus_{—}1=SliceGroupChangeRate−1;

slice_group_change_cycle=ceil (log 2(PicSizeInMapUnits/SliceGroupChangeRate+1));

The operators (=, *, /, −, +, ++) and the functions (log 2, ceil) are well known in relevant arts as per “C” language standard. The “>>” operator depicts bitwise shift to right of the first operand (by the value of second operand). Each bitwise shift to right by 1 is equivalent to dividing a number by 2, and as such the bitwise shift to right by 4 is equivalent to dividing a number by 16 (the width/height of a macro-block).

It may be observed that slice_group_change_direction_flag (one of the parameters) is assigned a constant 0 for the mapping types raster scan, WIPE and Box Out. The parameter shows the direction in which the slice group grows and 0 representing left to right for raster scan, top to bottom for WIPE and clock wise for Box Out types.

Thus, when source image frame 210 is to be divided into 2 regions of raster scan or WIPE or box out type, the intermediate variables and the parameters forwarded to the encoding block (220) are calculated as follows:

PicWidthInMbs=(176>>4)=11

PicHeightInMbs=(144>>4)=9

PicSizeInMapUnits=11 *9=99

SliceGroupChangeRate=(99/2)=49

slice_group_change_direction_flag=0

slice_group_change_rate_minus_{—}1=49−1=48

SliceGrpChangeCycleWidth=ceil (log 2(99/49+1))=2

Encoding block (220) receives the above calculated parameters from the parameter block (250) and uses the received parameters for encoding image frame 210. For raster scan type depicted in FIG. 4A, the macro-blocks are allocated using the macro-block to slice group algorithm specified in the H.264 standard section 8.2.2.5.

Accordingly slice group 410 is allocated in a left to right direction (slice_group_change_direction_flag=0) while progressing top to bottom until the count of macro-blocks reaches 48 (SizeofUpperLeftGroup) as described in section 8.2.2 in H.264 standard, based on slice_group_change_rate, slice_group_change_direction_flag, slice_group_change_cycle parameters and the remaining macro blocks allocated to the next slice group 415 (in the above noted example).

For WIPE type depicted in FIG. 4B, the macro-blocks are allocated using the macro-block to slice group algorithm specified in the H.264 standard section 8.2.2.6. Accordingly slice group 420 is allocated macro-blocks in a top to bottom direction (slice_group_change_direction_flag=0) while progressing left to right until the count of macro-blocks reaches 48 (SizeofUpperLeftGroup) as described in section 8.2.2 in H.264 standard, based on slice_group_change_rate, slice_group_change_direction_flag, slice_{group}_change_cycle parameters and the remaining macro blocks are allocated to the next slice group 425.

For box out type depicted in FIG. 4C, using the macro-block to slice group algorithm specified in the H.264 standard section 8.2.2.4 accordingly the macro-blocks are allocated to slice group 435 by starting at the central macro-block (m50) and progressing in a clock wise direction (slice_group_change_direction_flag=0) expanding in a box like fashion until the count of macro-blocks reach 48, with the remaining macro-blocks being allocated to the next slice group 430.

Thus, the regions for raster scan, WIPE and BOX types are calculated based on the dimensions of the image frame and the number of slice groups. The description is continued for computing the parameters to determine the regions for encoding in interleaved type.

7. Determining Regions for Interleaved Type

FIG. 4D depicts the manner in which an image frame is divided into slice groups according to interleaved type (or type-0 in H.264 standard) in one embodiment. The interleaved type is similar to the raster scan type, in that the blocks are allocated on each row from left to right (m1 to m11) while moving from top to bottom (that is, the first row m1-m11 followed by the second row m12-m22, and so on). However, the number of regions for interleaved type may be more than 2 in contrast to the raster scan type, where the number of regions is fixed as 2. It may be noted that the interleaved type macro-block mapping is fixed for all image frames, but raster scan type macro-block mapping can vary frame-by-frame basis.

Assuming that the number of slice groups is 3, image frame 210 may be accordingly divided into slice groups/regions 440, 445, 450 each containing 33 macro-blocks, as shown in FIG. 4D.

In H.264 standard, for the interleaved (type 0) type, the encoder requires run length parameters which specifies the number of consecutive macro-blocks to be assigned to each slice group (generally represented by the array “RunLength_SliceGrp[i]” where i represents the specific number of the slice group). The number of parameters computed depends upon the number of slice groups into which the image frame is to be divided (for example if the number of slice groups is 3 then the number of parameters required is 3).

The intermediate variables before calculating the parameters are calculated as follows in one embodiment:

RemainingMBs=PicSizeInMapUnits;

NumberOfMbsPerSlice=PicSizeInMapUnits/NumSliceGroups;

wherein,

RemainingMBs is a variable storing the number of macro-blocks that are available for allocation and is initially set to total number of macro-blocks in the image frame, and

NumberOfMbsPerSlice is the number of macro-blocks to be allocated to each slice group.

The required parameters are calculated as follows using the intermediate variables:

```
for (i = 0; i < NumSliceGroups − 1; i++)
{
  RunLength_SliceGrp[i] = NumberOfMbsPerSlice;
  RemainingMBs −= NumberOfMbsPerSlice;
}
```

RunLength_SliceGrp[NumSliceGroups−1]=RemainingMBs;

wherein “i” is a variable which represents the specific slice group to which the macro-blocks are being allocated and takes a value from 0 to the NumSliceGroups−2.

During each iteration of the “for” loop, the determined number of macro-blocks per slice group (as indicated by NumberOfMbsPerSlice) is allocated to the specific slice group and then the allocated number of blocks is subtracted from the remaining number of macro-blocks (as indicated by RemainingMBs).

After the completion of the “for” loop, the last slice group (having the index value NumSliceGroups−1) is allocated the remaining number of macro-blocks thus making sure no macro-block is left unallocated.

Thus, when source image frame 210 is to be divided into 3 slice groups for interleaved type, the computation of the intermediate variables and the parameters forwarded to the encoding block (220) are performed as follows:

RemainingMBs=99

NumberOfMbsPerSlice=99/3=33

RunLength_SliceGrp[0]=33

RunLength_SliceGrp[1]=33

RunLength_SliceGrp[2]=33

It may be noted in the above example the macro-blocks are equally (33) allocated into slice groups (3) as the number of macro-blocks in the image frame is 99. For example, in a case where the number of macro-blocks in the image frame is 100 and the number of slice groups is 3 the run lengths will be RunLength_SliceGrp[0]=33, RunLength_SliceGrp[1]=33, RunLength_SliceGrp[2]=34.

Encoding block 220 receives the above computed parameters from the parameters block 250 and uses the received parameters for encoding source image frame 210. For interleaved type depicted in FIG. 4D, the macro-blocks are allocated to slice group 440 in a left to right direction, while progressing top to bottom until the count of macro-blocks reaches 33 (RunLength_SliceGrp[0]), allocating the next 33 (RunLength_SliceGrp[1]) macro-blocks to the next slice group 445 and allocating the last 33 (RunLength_SliceGrp[2]) macro-blocks to slice group 450.

Thus, the regions for interleaved types are calculated based on the dimensions of the image frame and the number of slice groups. The description is continued for computing the parameters to determine the regions for encoding in foreground/background type.

8. Determining Regions for Foreground/Background Type

FIG. 4E depicts the manner in which an image frame is divided into slice groups according to foreground/background type (or type-2 in H.264 standard) in one embodiment. As per foreground/background type, the image frame is divided into overlapping or non-overlapping rectangular regions. In one embodiment, the rectangular regions are chosen to be concentric (with increasing size) and overlapping though the overlapping set of macro-blocks belongs to one region but not another. In general, overlapping macroblocks are considered for lower index of slice group and remaining macroblocks for higher index of slice groups.

Assuming that the number of slice groups is 3, source image frame 210 may be divided into rectangles 460, 465, 470. All the macro-blocks within rectangle 470 are considered one slice group, the macro-blocks in rectangle 465 that do not overlap with rectangle 470 are considered the second slice group, and the rest in the periphery are considered to be part of the third slice group.

In one embodiment, the H.264 encoder requires values corresponding to four parameters for each slice group when encoding an image frame according to the foreground/background (type 2) type. The parameter required are the coordinates of the top-left macro-block (represented by variables TopLeftMBX[i], TopLeftMBY[i]) and the bottom-right macro-block (represented by variables BottomRightMBX[i], BottomRightMBY[i]) of each of the region/slice group as described in section 8.2.2.3 of H.264 standard. Further the total number of parameters would depend upon the number of slice groups (input NumSliceGroups) into which the image frame has to be divided (for example, when NumSliceGroups is 3, the number of required parameters will be 12).

It may be noted that the variable “i” represents the specific number of the slice group and TopLeftMBX, TopLeftMBY, BottomRightMBX and BottomRightMBY are arrays which stores the top-left X co-ordinate, top-left Y co-ordinate, bottom-right X co-ordinate and bottom-right Y co-ordinate respectively for each of the slice group represented by the specific number.

In one approach, the slice groups/regions are initialized as being located in the center of the image and having unit width and height in terms of macro blocks. Macro-blocks are allocated to a first region (in the order of left, right, top, and bottom directions) until the number of macro-blocks assigned for the region is reached. The next region is then initialized to the boundaries of the first region and the above process is repeated for allocating the macro-blocks to the next region. The last region is allocated the macro-blocks that are left over after the previous allocations.

The regions/slice groups may be initialized to the central macro-block of the image frame as follows:

```
Center_X = ((PicWidthInMbs + 1) >> 1);
Center_Y = ((PicHeightInMbs + 1) >> 1);
for (i = 0; i < NumSliceGroups − 1; i++)
{
  TopLeftMBX[i] = BottomRightMBX[i] = Center_X;
  TopLeftMBY[i] = BottomRightMBY[i] = Center_Y;
}
```

where Center_X, Center_Y respectively stores the value of the X and Y positions of the central macro-block in the image frame, and the top-left and bottom-right co-ordinates for all the slice groups in the image frame are initialized to the central macro-block as shown by the “for” loop above.

To begin with, the specific number of the slice group is set (i=0). A check is performed to make sure the specific number is not the number of the last slice group (part of the outer while loop). The maximum number of macro-blocks that may have been allocated at the end of the process of allocation to the specific slice group is calculated and assigned to the variable MBsForSliceGroup. An infinite loop is begun (at while (1)) for the allocation of macro-blocks to the specific slice group:

```
i = 0;
while (i < NumSliceGroups − 1)
{
    MBsForSliceGroup = NumberOfMbsPerSlice*(i + 1);
  while (1)
```

The total number of macro-blocks to be allocated is calculated. If the allocated number of macro-blocks is less than the variable MBsForSliceGroup then the calculation is continued as shown below:

```
  {
    SliceGrpMBs = (BottomRightMBY[i] − TopLeftMBY[i]
+1)*(BottomRightMBX[i] − TopLeftMBX[i] + 1);
    if (SliceGrpMBs < MBsForSliceGroup)
```

If the top-left X co-ordinate is within the limit of the image frame size the allocated number of macro-blocks is calculated assuming the expansion of the rectangle is going to happen on the left side and if the calculated number is less than the variable MBsForSliceGroup the top-left X co-ordinate is decremented by 1 for expanding the slice group on the left side as shown below:

```
  {
    if (TopLeftMBX[i] − 1 >= 0)
      SliceGrpMBs = (BottomRightMBY[i]−TopLeftMBY[i] +
1 ) * (BottomRightMBX [i] − TopLeftMBX[i] + 2);
    if (SliceGrpMBs < MBsForSliceGroup)
    {
      if (TopLeftMBX[i] − 1 >= 0)
        TopLeftMBX[i] = TopLeftMBX[i] − 1;
```

If the bottom-right X co-ordinate is within the limit of the image frame size then the allocated number of macro-blocks is calculated assuming the expansion of the rectangle is going to happen on the right side and the if the calculated number is less than the variable MBsForSliceGroup the bottom-right X co-ordinate is incremented by 1 for expanding the slice group on the right side as shown below:

```
  if (BottomRightMBX[i] + 1 <= PicWidthInMbs − 1)
    SliceGrpMBs = (BottomRightMBY[i] − TopLeftMBY[i] +
1)*(BottomRightMBX[i] − TopLeftMBX[i] + 2);
  if (SliceGrpMBs < MBsForSliceGroup)
  {
    if (BottomRightMBX[i] + 1 <= PicWidthInMbs − 1)
      BottomRightMBX[i] = BottomRightMBX[i] + 1;
```

If the top-left Y co-ordinate is within the limit of the image frame size the allocated number of macro-blocks is calculated assuming the expansion of the rectangle is going to happen on the top side and the if the calculated number is less than the variable MBsForSliceGroup the top left Y co-ordinate is decremented by 1 for expanding the slice group on the top as shown below:

```
  if (TopLeftMBY[i] − 1 >= 0)
    SliceGrpMBs = (BottomRightMBY[i] − TopLeftMBY[i] +
2) * (BottomRightMBX[i] − TopLeftMBX[i] + 1);
  if (SliceGrpMBs < MBsForSliceGroup)
  {
    if (TopLeftMBY[i] − 1 >= 0)
      TopLeftMBY[i] = TopLeftMBY[i] − 1;
```

If the bottom-right Y co-ordinate is within the limit of the image frame size the allocated number of macro-blocks is calculated assuming the expansion of the rectangle is going to happen on the bottom side and the if the calculated number is less than the variable MBsForSliceGroup the bottom-right Y co-ordinate is incremented by 1 for expanding the slice group on the bottom as shown below:

```
  if (BottomRightMBY[i] + 1 <= PicHeightInMbs − 1)
    SliceGrpMBs = (BottomRightMBY[i] − TopLeftMBY[i] +
2) * (BottomRightMBX[i] − TopLeftMBX[i] + 1);
  if (SliceGrpMBs < MBsForSliceGroup)
  {
    if (BottomRightMBY[i] + 1 <= PicHeightInMbs − 1)
      BottomRightMBY[i] = BottomRightMBY[i] + 1;
```

Any of the checks made above fails then the execution breaks out of the infinite loop. Once the execution breaks out of the infinite loop specific number of the slice group is incremented by 1 (i++).

The co-ordinates for the specific (incremented value) slice group are initialized to the previous slice group co-ordinates or boundaries of the previously allocated rectangle. If the specific (incremented value) slice group is the last slice group then the execution of the outer while loop ends and if the specified slice group is not the last slice group then the execution continues starting with the new calculation for the variable MBsForSliceGroup and entering the outer while loop as shown below:

```
  TopLeftMBX[i] = TopLeftMBX[i − 1];
  TopLeftMBY[i] = TopLeftMBY[i − 1];
  BottomRightMBX[i] = BottomRightMBX[i − 1];
  BottomRightMBY[i] = BottomRightMBY[i − 1];
} /* end of outer while loop */
```

For the last slice group the co-ordinates on each of the edges of the image frame is assigned as shown below thus making sure no macro-blocks are left un-allocated as shown below:

TopLeftMBX[NumSliceGroups−1]=0;

TopLeftMBY[NumSliceGroups−1]=0;

BottomRightMBX[NumSliceGroups−1]=PicWidthInMbs−1;

BottomRightMBY[NumSliceGroups−1]=PicHeightInMbs−1;

In one embodiment it may be required to calculate the maximum number of macro-blocks allocated among the allocations made to the different slice groups. The calculation may be performed as follows. The calculation sought to be performed each time at the end of determining one rectangular region (slice group) as shown below:

```
  ConsumedMBs = (BottomRightMBY[i] −
TopLeftMBY[i] + 1) * (BottomRightMBX[i] − TopLeftMBX[i] +
1);
  if (MaxMBsInSliceGrp < ConsumedMBs − PrevConsumedMBs)
  {
    MaxMBsInSliceGrp = ConsumedMBs − PrevConsumedMBs;
  }
  PrevConsumedMBs = ConsumedMBs;
wherein,
```

ConsumedMBs stores the total number of macro-blocks that have been allocated,

PrevConsumedMBs stores the total number of allocated macro-blocks till the previous slice group, and

MaxMBsInSliceGrp stores the value of the maximum number of macro-blocks allocated among the different slice groups. The variable MaxMBsInSliceGrp is calculated for the allocation of memory (storage not shown) for storing encoded slice groups.

Thus, when source image frame 210 is to be divided into 3 regions of foreground/background type, the calculations are performed using the above set of software instructions in one embodiment as follows:

```
  Center_X = 6
  Center_Y = 5
  MBsForSliceGroup = 33 (for slice group 0)
  MBsForSliceGroup = 66 (for slice group 1)
  TopLeftMBX[0] = 3, TopLeftMBY[0] = 3,
BottomRightMBX[0] = 8,
BottomRightMBY[0] = 7
  TopLeftMBX[1] = 1, TopLeftMBY[1] = 2,
BottomRightMBX[1] = 9,
BottomRightMBY[1] = 8
  TopLeftMBX[2] = 0, TopLeftMBY[2] = 0,
BottomRightMBX[2] = 10,
BottomRightMBY[2] = 8
```

Encoding block 220 receives the above calculated parameters from the parameters block 250 and using the received parameters divides source image frame 210 into regions/slice groups. In case of non-overlapping rectangles, the number of blocks in a region and the corners information determines the specific blocks in the slice group.

When the rectangles overlap, as in FIG. 4E, encoding block may first determine the inner most slice group (closest to the centre), allocate specific blocks to this first slice group based on the corresponding corner coordinates and number of blocks. Encoding block may expand out thereafter and continue to allocate blocks to each of the subsequent/remaining slice groups.

Thus, the first/innermost slice group (m37-m42, m48-m53, m59-m64, m70-m75, m85-m86) has top-left co-ordinates (3, 3) and bottom-right co-ordinates (8, 7). The blocks for the second slice group (m24-m32, m35-,36, m43, m46-m47, m54, etc.) are allocated starting from top-left co-ordinates (1, 2) and bottom-right co-ordinates (9, 8), while ensuring no overlap with the first slice group. The third slice group has top-left co-ordinates (0,0) and the bottom-right co-ordinates (10, 8) for foreground/background type.

It may be appreciated that the division of the regions from the center of the image frame in the foreground/background type, different regions may be encoded using different levels of compression, for example, the main region (470) of the image frame may be encoded with less loss/more quality and with the other slice groups 465 and 460 being encoded with more loss/lower quality.

Though the features above have been described in terms of software instructions, it should be appreciated that various aspects of the present invention can be implemented in a desired combination of hardware, software and firmware. The description is continued with respect to an embodiment in which the features are operative upon execution of software instructions.

9. Software Implementation

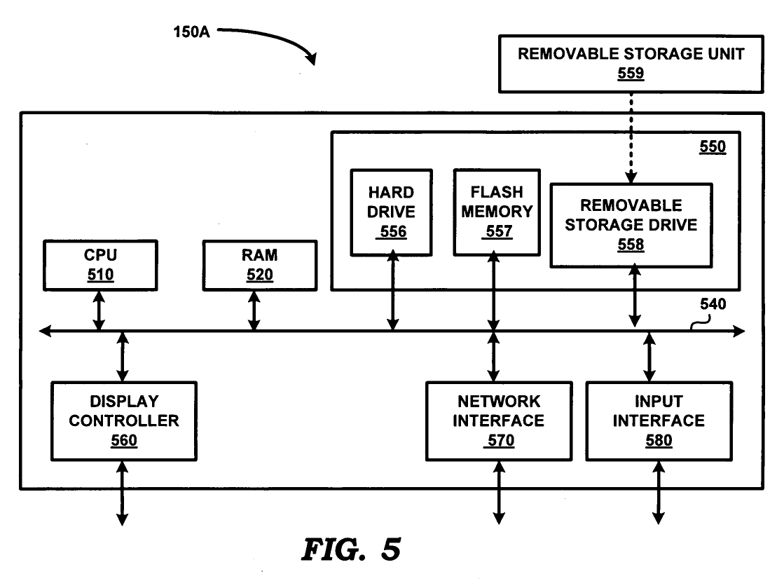

FIG. 5 is a block diagram illustrating the details of processing unit 150A in an embodiment. The description below also applies to processing unit 150B. Processing unit 150A may contain one or more processors such as central processing unit (CPU) 510, random access memory (RAM) 520, secondary storage unit 550, display controller 560, network interface 570, and input interface 580. All the components may communicate with each other over communication path 540, which may contain several buses as is well known in the relevant arts. The components of FIG. 5 are described below in further detail.

CPU 510 may execute instructions stored in RAM 520 to provide several features of the present invention. CPU 510 may contain multiple execution units, with each execution unit potentially being designed for a specific task. Alternatively, CPU 510 may contain only a single general-purpose processing unit.

RAM 520 may receive instructions from secondary storage unit 550 using communication path 540. In addition, RAM 520 may store video frames received from a video camera (130A) during the encoding operations noted above. Similarly, RAM 520 may be used to store encoded video frames received on path 155, as well as video frames decoded therefrom. Display controller 560 generates display signals (e.g., in RGB format) to display unit 170B (FIG. 1) based on data/instructions received from CPU 510.

Network interface 570 provides connectivity to a network (e.g., using Internet Protocol), and may be used to receive/transmit compressed/encoded video/image frames or regions of image frames on path 155 of FIG. 1. Input interface 580 may include interfaces such as keyboard/mouse, and interface for receiving video frames from video camera 130A.

Secondary storage unit 550 may contain hard drive 556, flash memory 557, and removable storage drive 558. Some or all of the data and instructions may be provided on removable storage unit 559, and the data and instructions may be read and provided by removable storage drive 558 to CPU 510. Floppy drive, magnetic tape drive, CD-ROM drive, DVD Drive, Flash memory, removable memory chip (PCMCIA Card, EPROM) are examples of such removable storage drive 558.

Alternatively, data and instructions may be copied to RAM 520 from which CPU 510 may read and execute the instructions using the data. Removable storage unit 559 may be implemented using medium and storage format compatible with removable storage drive 558 such that removable storage drive 558 can read the data and instructions. Thus, removable storage unit 559 includes a computer readable (storage) medium having stored therein computer software and/or data.

In general, the computer (or generally, machine) readable medium refers to any medium from which processors can read and execute instructions. The medium can be randomly accessed (such as RAM 520 or flash memory 557), volatile, non-volatile, removable or non-removable, etc. While the computer readable medium is shown being provided from within processing unit 150A for illustration, it should be appreciated that the computer readable medium can be provided external to processing unit 150A as well.

In this document, the term “computer program product” is used to generally refer to removable storage unit 559 or hard disk installed in hard drive 556. These computer program products are means for providing software to CPU 510. CPU 510 may retrieve the software instructions, and execute the instructions to provide various features of the present invention described below. Groups of software instructions in any form (for example, in source/compiled/object form or post linking in a form suitable for execution by CPU 510) are termed as code.

Several aspects of the invention are described below with reference to examples for illustration. It should be understood that numerous specific details, relationships, and methods are set forth to provide a full understanding of the invention. For example, many of the functions units described in this specification have been labeled as modules/blocks in order to more particularly emphasize their implementation independence.

A module/block may be implemented as a hardware circuit containing custom very large scale integration circuits or gate arrays, off-the-shelf semiconductors such as logic chips, transistors or other discrete components. A module/block may also be implemented in programmable hardware devices such as field programmable gate arrays, programmable array logic, programmable logic devices, or the like.

Modules/blocks may also be implemented in software for execution by various types of processors. An identified module of executable code may, for instance, contain one or more physical or logical blocks of computer instructions which may, for instance, be organized as an object, procedure, or function. Nevertheless, the executables of an identified module need not be physically located together, but may contain disparate instructions stored in different locations which when joined logically together constitute the module/block and achieve the stated purpose for the module/block.

It may be appreciated that a module/block of executable code could be a single instruction, or many instructions and may even be distributed over several code segments, among different programs, and across several memory devices. Further, the functionality described with reference to a single module/block can be split across multiple modules/blocks or alternatively the functionality described with respect to multiple modules/blocks can be combined into a single (or other combination of blocks) as will be apparent to a skilled practitioner based on the disclosure provided herein.

Reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

Furthermore, the described features, structures, or characteristics of the invention may be combined in any suitable manner in one or more embodiments. In the following description, numerous specific details are provided such as examples of programming, software modules, user selections, network transactions, database queries, database structures, hardware modules, hardware circuits, hardware chips, etc., to provide a thorough understanding of embodiments of the invention.

However one skilled in the relevant art will recognize that the invention can be practiced without one or more of the specific details or with other methods, components, materials and so forth. In other instances, well-known structures, materials, or operations are not shown in detail to avoid obscuring the features of the invention. Further more the features/aspects described can be practiced in various combinations, though only some of the combinations are described herein for conciseness.

10. Conclusion

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

It should be understood that the figures and/or screen shots illustrated in the attachments highlighting the functionality and advantages of the present invention are presented for example purposes only. The present invention is sufficiently flexible and configurable, such that it may be utilized in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way

What is claimed is:

1. A machine readable medium carrying one or more sequences of instructions for causing a system to process image frames, wherein execution of said one or more sequences of instructions by one or more processors contained in said system causes said system to perform the actions of:
receiving an indication that an image frame is to be encoded using a number of regions of a first type;
allocating a plurality of blocks of said image frame into said number of regions formed according to said first type;
calculating the values of a plurality of parameters after said receiving; and
encoding each of said number of regions using the calculated values for said plurality of parameters.

2. The machine readable medium of claim 1, wherein the calculated values for said plurality of parameters determine a start block in each of the regions and a sequence in which the blocks in the region are to be selected by said encoding for said first type.

3. The machine readable medium of claim 2, wherein said receiving step receives a second image frame with an indication that said second image frame is to be encoded using a second number of regions of a second type,
wherein said allocation step allocates the blocks of said second image frames into said number of regions formed according to said second type,
said calculating step calculates the corresponding values for a second plurality of parameter according to said second type,
said encoding step encodes each region of said second image frame using the calculated values for said second plurality of parameters,
wherein said second type is not the same as said first type.

4. The machine readable medium of claim 2, further comprising:
determining a number of blocks in said image frame based on a number of pixels in each dimension of said image frame and a block size used by said encoding,
wherein said allocating is performed based on said determined number of blocks and said number of regions.

5. The machine readable medium of claim 2, wherein said first type is one of raster scan, WIPE, box out,
wherein said plurality of parameters comprise a slice group change rate and a slice group change cycle,
wherein said encoding receives values for said plurality of parameters and a direction flag, said encoding determining said sequence according to said direction flag and specific blocks in each region according to said slice group change rate and said slice group change cycle.

6. The machine readable medium of claim 2, wherein said first type is interleaved type,
wherein said plurality of parameters comprise a run-length for each of said number of regions, said run-length indicating a number of a blocks in the corresponding region,
wherein said encoding determines said start block for a first region as a corner of said image frame, and the start block for subsequent regions based on the run-length of the previous regions,
wherein said encoding determines said sequence as equaling a raster scan order starting from the corresponding start block.

7. The machine readable medium of claim 2, wherein said first type is foreground/background type formed from a plurality of concentric rectangles,
wherein said plurality of parameters indicate the corners of each of said plurality of rectangles,
wherein said encoding uses a block at a corner of each of said plurality of rectangles as said start block and said sequence is determined according to a scan order.

8. A method of processing image frames, said method comprising:
receiving an indication that an image frame is to be encoded using a number of regions of a first type;
allocating a plurality of blocks of said image frame into said number of regions formed according to said first type;
calculating the values of a plurality of parameters after said receiving; and
encoding each of said number of regions using the calculated values for said plurality of parameters.

9. The method of claim 8, wherein the calculated values for said plurality of parameters determine a start block in each of the regions and a sequence in which the blocks in the region are to be selected by said encoding for said first type.

10. The method of claim 9, wherein said receiving step receives a second image frame with an indication that said second image frame is to be encoded using a second number of regions of a second type,
wherein said allocation step allocates the blocks of said second image frames into said number of regions formed according to said second type,
said calculating step calculates the corresponding values for a second plurality of parameter according to said second type,
said encoding step encodes each region of said second image frame using the calculated values for said second plurality of parameters,
wherein said second type is not the same as said first type.

11. The method of claim 9, wherein said first type is one of raster scan, WIPE, box out,
wherein said plurality of parameters comprise a slice group change rate and a slice group change cycle,
wherein said encoding receives values for said plurality of parameters and a direction flag, said encoding determining said sequence according to said direction flag and specific blocks in each region according to said slice group change rate and said slice group change cycle.

12. The method of claim 9, wherein said first type is interleaved type,
wherein said plurality of parameters comprise a run-length for each of said number of regions, said run-length indicating a number of a blocks in the corresponding region,
wherein said encoding determines said start block for a first region as a corner of said image frame, and the start block for subsequent regions based on the run-length of the previous regions,
wherein said encoding determines said sequence as equaling a raster scan order starting from the corresponding start block.

13. The method of claim 9, wherein said first type is foreground/background type formed from a plurality of concentric rectangles,
wherein said plurality of parameters indicate the corners of each of said plurality of rectangles,
wherein said encoding uses a block at a corner of each of said plurality of rectangles as said start block and said sequence is determined according to a scan order.

14. An encoder to encode a sequence of image frames, said encoder comprising:
a parameters block to receive an indication that an image frame is to be encoded using a number of regions of a first type, said parameter block to compute a corresponding number of blocks to be allocated to each of said regions based on said number, said type, a size of said image frame and a block size; and
an encoding block to receive a sequence of pixel values representing said image frame, said encoding block to encode said image frame into said number of regions, with each region containing said corresponding number of blocks.

15. The encoder of claim 14, wherein said parameters block further computes the values of a plurality of parameters after said receiving of said first type and said number of regions,
wherein said encoding block determines a corresponding set of blocks in each of the regions, a start block in each set of blocks, and a sequence of each set of blocks based on the values of said plurality of parameters and said first type.

16. The encoder of claim 15, wherein said parameter block is designed to receive an indication that a second image frame is to be encoded using a second number of regions of a second type, said parameter block computing the values for another set of parameters corresponding to said second type and also a corresponding number of blocks in each of said second number of regions,
said encoding block to encode said second image frame in said number of regions, with each region including the corresponding number of blocks, said encoding block using the values of said another set of parameters to determine a start block in each of said regions and a sequence of blocks within each region,
wherein said second type is not the same as said first type.

17. The encoding block of claim 15, wherein said parameters block computes said number of blocks in each dimension of a slice by dividing a number of pixels in the same dimension of said image frame by a number of pixels in the same dimension of each block.

18. The encoding block of claim 15, wherein said first type is one of raster scan, WIPE, box out,
wherein said plurality of parameters comprise a slice group change rate and a slice group change cycle,
wherein said encoding block is designed to receive values for said plurality of parameters and a direction flag from said parameters block, said encoding block to determine said sequence according to said direction flag and specific blocks in each region according to said slice group change rate and said slice group change cycle.

19. The encoding block of claim 15, wherein said first type is interleaved type,
wherein said plurality of parameters comprise a run-length for each of said number of regions, said run-length indicating a number of a blocks in the corresponding region,
wherein said encoding block is designed to determine said start block for a first region as a corner of said image frame, and the start block for subsequent regions based on the run-length of the previous regions,
wherein said encoding block is also designed to determine said sequence as equaling a raster scan order starting from the corresponding start block.

20. The encoding block of claim 15, wherein said first type is foreground/background type formed from a plurality of concentric rectangles as corresponding regions,
wherein said plurality of parameters indicate the corners of each of said plurality of rectangles,
wherein said encoding block is designed to use a block at a corner of each of said plurality of rectangles as said start block and said sequence is determined according to a scan order.
